(19) United States
(12) Patent Application Publication
(10) Pub. No.: US 2013/0212363 A1
(43) Pub. Date: Aug. 15, 2013

(54) MACHINE TRANSPORT AND EXECUTION OF LOGIC SIMULATION

(71) Applicant: GRAYSKYTECH LLC, (US)

(72) Inventor: JERROLD LEE GRAY, WOODINVILLE, WA (US)

(73) Assignee: GRAYSKYTECH LLC, WOODINVILLE, WA (US)

(21) Appl. No.: 13/851,859

(22) Filed: Mar. 27, 2013

Related U.S. Application Data
(63) Continuation-in-part of application No. 13/476,000, filed on May 20, 2012.
(60) Provisional application No. 61/488,540, filed on May 20, 2011.

(51) Int. Cl. G06F 9/30

(52) U.S. Cl. CPC G06F 9/30029
USPC 712/223

(57) ABSTRACT

Technologies related to machine transport and execution of logic simulation. In some examples, logic simulation systems may cyclically calculate logic state vectors based on the current state and inputs into the system. The state vector is a state of a logic storage element in a model. State vectors may be distributed from a core of common memory to one or more arrays of processors to compute the next state vector. The one or more arrays of processors are connected with arrays of logic processors and memory for efficiency and speed.

### CROSS REFERENCE TO RELATED APPLICATIONS

This is a continuation in part of U.S. patent application Ser. No. 13/476,000, filed May 20, 2012, entitled “MACHINE TRANSPORT AND EXECUTION OF LOGIC SIMULATION”, which is a non-provisional of U.S. Provisional Application No. 61/488,540, filed May 20, 2011, entitled “MACHINE TRANSPORT AND EXECUTION OF LOGIC SIMULATION”. The prior applications are incorporated by reference.

### BACKGROUND

This disclosure relates to the field of model simulation and more specifically to methods of data distribution and distributed execution that enable the design and execution of superior machines used in logic simulation.

Most logic simulation is performed on conventional Central Processing Unit (CPU) based computers ranging in size and power from simple desktop computers to massively parallel super computers. These machines are typically designed for general purposes and contain little or no optimizations that specifically benefit logic simulation.

Many computing systems (including DSPs and embedded micro controllers) are based on a complex machine language (assembly and/or microcode) with a large instruction set commensurate with the need to support general-purpose applications. These large instruction sets reflect the general-purpose need for complex addressing mode, multiple data types, complex test-and-branch, interrupt handling and use of various on-chip resources. Digital Signal Processors (DSPs) and CPUs provide generic processors that are specialized with software (high-level, assembly or microcode).

There have been previous attempts to create faster processing for specific types of data, for example the Logic Processing Unit (LPU). The LPU is a small Boolean instruction set with logic variables based on 2-bit representations (0, 1, undefined, tri-state). However, there were processing shortcomings in the LPU because it is still a sequential machine performing one instruction at a time and on one bit of logic at a time.

More specific types of numerical processing, for example logic simulation, have utilized unique hardware to achieve performance in specific analysis. While this is effective for processing or acting on a given set of data in a time efficient manner, it does not provide the scalability required for the very large models needed today and even larger in the future.

Another shortcoming of current computing systems is the lack of machine optimizations of Boolean logic within the general CPUs. The combined lack of specialized CPU instructions and a desire to off-load CPU processing has led to an explosion of graphics card designs over the years. Many of these graphics cards have been deployed as vector co-processors on non-graphic applications merely due to the nature of the types of data and graphic card machine processing being similar.

Data types defined by IEEE standards for logic are based on an 8-bit representation for both logic nodes and storage within VHSIC Hardware Description Language (VHDL), Verilog, as well as other Hardware Description Languages (HDLs). Many simulation systems have means of optimizing logic from 2 to 4 bits to make storage and transport more efficient. Yet, CPUs cannot directly manipulate these representations because they are not “native” to the CPU and they have to be calculated with high or low level code.

Logic synthesis tools from various tool providers have demonstrated that arbitrary logic can be represented by very small amounts of data. This is evidenced by the fact that tools can successfully target families of Field Programmable Gate Arrays (FPGAs) and Application Specific Integrated Circuits (ASICs), which are based on very simple logic primitives.

HDL compilers often generate behavior models for simulation and logic structures for synthesis. Simulation behavior models are a part of the application layer which is built from some high level language which is independent of machine form, but whose throughput is dependent on the CPU machine, the machine language, and the operating system.

Logic simulation across multiple Personal Computer (PC) platforms is not practical and current simulation software cannot take advantage of multiple core CPUs. In multiple core CPUs, the individual cores support very large instruction sets and very large addressing modes. Although the individual cores share some resources, they are designed to work independently. Each core consumes an enormous amount of silicon area per chip so that CPUs found in common off-the-shelf PCs may contain only 2 to 8 cores.

Chips that contain over eight cores (for example, the Raport chip, which currently has the largest number of cores with 256 processors), are more or less designated for embedded applications or functions peripheral to a CPU. These individual cores are still rather complex general-purpose processors on the scale of 8-bit and 16-bit processors in the early days of the first microprocessors (8008, 8085, 8086, etc.) with smaller address space.

### SUMMARY

The present disclosure generally describes technologies including devices, methods, and computer readable media relating to machine transport and execution of logic simulation. Some example methods may comprise storing a state vector in a computational memory; distributing, by each of multiple data stream controllers, an input comprising a portion of the state vector for processing by a sub-array of computational logic processors, wherein each of the multiple data stream controllers is coupled with a different sub-array of computational logic processors; processing the inputs by a product term latching comparator within each of the computational logic processors; sending, by the computational logic processors, computational results of processing the inputs to the intermediate the data stream controllers; sending the computational results, by the data stream controllers, to the computational memory; and assembling the computational results into a new state vector in the computational memory.

In some embodiments, one or more of the computational logic processors may be configured to comprise a Boolean computational logic processor or a real time computational logic processor. In some embodiments, one or more of the computational logic processors may be configured to provide modeling of logic constructions.

In some embodiments, one or more of the computational logic processors may be configured to comprise a Field Programmable Gate Array (FPGA) or an Application Specific Integrated Circuit (ASIC).

In some embodiments, one or more of the computational logic processors comprising a real-time computational logic processor may be configured to perform real-time look-ups by the real-time computational logic processor to determine timing of logic propagation and transition to simulate behavior of a physical circuit simulated by the logic simulation method.

Some example systems may comprise a computational memory configured to store an input state vector; one or more deterministic data buses coupled with the computational memory, each of the deterministic data buses configured to propagate input and output state vector data; multiple data stream controllers coupled with the one or more deterministic data buses, each of the data stream controllers configured to manage steps in a computational cycle completed by multiple computational logic processors; and a plurality of sub-arrays of computational logic processors, each sub-array coupled with a data stream controller, wherein each of the computational logic processors comprises a product term latching comparator configured to compute a portion of a next state vector from the input state vector.

In some embodiments, one or more of the computational logic processors may be configured to comprise a Boolean computational logic processor or a real time computational logic processor. In some embodiments, one or more of the computational logic processors may be configured to provide modeling of logic constructions.

In some embodiments, one or more of the computational logic processors may be configured to comprise a Field Programmable Gate Array (FPGA) or an Application Specific Integrated Circuit (ASIC).

In some embodiments, one or more of the computational logic processors comprising a real-time computational logic processor may be configured to comprise a real time look up engine configured to perform real-time look-ups to determine timing of logic propagation and transition to simulate behavior of a physical circuit simulated by the logic simulation system.

In some embodiments, the system may comprise a host processor configured to run a simulation cycle, comprising triggering a simulation cycle and transmitting test fixture inputs and outputs.

In some embodiments, one or more of the computational logic processors may be configured to comprise a Boolean computational logic processor or a real time computational logic processor coupled with a dual port RAM, a Vector State Stream (VSS) module, and a deterministic data bus, wherein the dual port RAM is configured to store instructions, logic expression tables, and assigned input vectors, and wherein the VSS module is configured to splice input state vectors into components and to recombine computed output vector data into the deterministic data bus.

In some embodiments, the VSS module coupled to the real time computational logic processor may be configured to comprise a RAM based FIFO configured to sort output vector data based on time of change before the output vector is released to the deterministic data bus.

A multiplicity of superior computing engines, data transports and storage may comprise a redefinition of logic data, as well as a redefinition of logic data transport, expression, and execution. Improved data and functional definition and the development of superior machines does not necessarily require a re-definition of the host CPU, but can be applied in peripheral design.

Other features, objects and advantages of this disclosure will become apparent from the following description, taken in connection with the accompanying drawings, wherein, by way of illustration, example embodiments of the invention are disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a block diagram illustrating an example computing system with a simulation engine.

FIG. 2 is a block diagram illustrating an example simulation engine PCI plug-in card with logical modules.

FIG. 3 is a block diagram illustrating an example Boolean Logic ASP and its integration with a VSS bus.

FIG. 4 is an example set of tables illustrating a definition of a state vector element and a composite state vector used for data storage and transport.

FIG. 5 is an example set of tables illustrating a definition of the Logic Expression Table (LET) used to define synthesized logic models for simulation.

FIG. 6 is a block diagram illustrating an example Product Term Latching Comparator (PTLC).

FIG. 7 is a block diagram illustrating an example Real Time Logic ASP and its integration with a VSS bus.

FIG. 8 is a flow diagram illustrating an example method configured to simulate a logic cycle from a host software perspective.

FIG. 9 is a pie chart of a mixed mode model.

### DETAILED DESCRIPTION

Detailed descriptions of various embodiments are provided herein. Specific details disclosed herein are not to be interpreted as limiting, but rather as a basis for the claims and as a representative basis for teaching one skilled in the art to employ the present invention in virtually any appropriately detailed system, structure or manner.

The present disclosure is generally drawn, inter alia, to technologies including methods, devices, systems and/or computer readable media deployed therein relating to machine transport and execution of logic simulation. In some examples, logic simulation systems may cyclically calculate logic state vectors based on the current state and inputs into the system. A state vector may comprise a state of a logic storage element in a model. State vectors may be distributed from a core of common memory to one or more arrays of processors to compute a next state vector. The one or more arrays of processors may be connected with data stream controllers and memory for efficiency and speed.

For example, in some embodiments, a computing system may be configured to comprise a simulation system, wherein the simulation system comprises a computational memory, one or more deterministic data buses coupled with the computational memory, multiple data stream controllers coupled with the one or more deterministic data buses, and a plurality of logic processors. The simulation system, which may be referred to as a simulation engine, is a computing engine for simulation.

Simulation can be understood as a cyclic process of calculating the next state of a model based on the current state and inputs to the system. In logic systems the state of a model may be referred to as the “state vector.” The “current state vector” is defined as current state of all the logic storage elements (flip-flops, RAM, etc.) that are present in the model.

Logic simulation can be understood as a “discrete” calculation of logic state vectors, wherein “cycle based” or Boolean calculations are performed without respect to logic propagation delays and “real time” calculations account for logic propagation delays. Combined cycle based and real time calculations in a single simulation are referred to as “mixed mode,” although in some contexts, this term has been extended to include continuous modeling such as found in Simulation Program with Integrated Circuit Emphasis (SPICE).

In some embodiments, computational memory of the simulation engine may be configured to store state vectors. A simulation engine that has state vectors loaded into computational memory may be configured to distribute, by each of the multiple data stream controllers, an input comprising a portion of the state vector for processing by a sub-array of computational logic processors. Each of the multiple data stream controllers may be configured to be coupled with a different sub-array of computational logic processors. In some embodiments, the Product Term Latching Comparator (PTLC) within each of the computational logic processors may be configured to process the inputs.

Processing of a primitive portion of the state vector (a single memory element) can be accomplished with a simple set of rules. Bits and words can be processed with a small instruction set on a logic specific processor core much smaller in silicon area than those described above, such that chips built from this technology could contain thousands of processor cores. These Random Access Memory (RAM) based processor cores can be configured with conventional machine language code augmented by RAM based synthetic machine instructions compiled from the user's source code HDL. This enables the core to efficiently emulate one or more pieces of the overall model to a high level of efficiency and speed.

The deterministic nature of simulation allows for the use of deterministic methods of connecting arrays of logic processors and memory. These deterministic methods are usually defined as “buses” rather than “networks” and techniques are generally referred to as “data flow.” These are considered tightly coupled systems of very high throughput.

In some embodiments, physical data flow architectures described herein can be configured to distribute state vectors from a core of common memory to one or more arrays of processors to compute the next state vector, which is returned to the core of common memory.

In some embodiments, the one or more computational logic processors may be configured to comprise a Field Programmable Gate Array (FPGA) or an Application Specific Integrated Circuit (ASIC). In some embodiments, the one or more computational logic processors may be configured to provide modeling of logic constructions. In some embodiments, the one or more computational logic processors may be configured to comprise a Boolean computational logic processor, a real-time computational logic processor, or a logic specific Von Neumann processor. In some embodiments, the real-time computational logic processor may be configured to perform real-time look-ups to determine timing of logic propagation and transition to simulate behavior of a physical circuit simulated by the logic simulation engine.

In some embodiments, one or more of the computational logic processors may be configured to comprise a Boolean computational logic processor or a real time computational logic processor coupled with a dual port RAM, a Vector State Stream (VSS) module, and a deterministic data bus, wherein the dual port RAM is configured to store instructions, logic expression tables, and assigned input vectors, and wherein the VSS module is configured to splice large input state vectors into smaller components and to recombine computed output vector data into the deterministic bus. In some embodiments, the VSS module coupled to the real time computational logic processor may be configured to comprise a RAM based First-In First-Out (FIFO) configured to sort output vector data based on time of change before the output vector is released to the deterministic bus.

In some embodiments, the simulation engine may be configured to provide a compact “true logic” Sum Of Product (SOP) representation of the logical Boolean formulas relating combinatorial inputs to output in any logic tree. In some embodiments, the simulation engine may be configured to facilitate algorithmically reduced synthesized logic by utilizing a SOP form of logic representation in machine code compatible with the aforementioned logic specific processors. This form and machine operation supports input and output inversions and simultaneous computation of multiple inputs and outputs.

In some embodiments, the simulation engine may be configured to provide efficient notation for positive and negative edge propagation, such that machine code can calculate delays in the combinatorial data path for “real-time” logic processors.

In some embodiments, a state vector may be configured to be partially or completely contained in common memory, formatted in a known form, distributed in a deterministic bus to a sea of logic processors, and returned to the common memory through the same or similar deterministic bus.

A deterministic bus may be characterized as a bus which has no ambiguity of content at any time or phase; the communication format is predetermined so there is no decision making at the level of the protocol. Whether the content is parallel and/or serial is determined by properties like time slots, delimiters, pre-defined formats, fixed protocols, markers, flags, IDs and chip selects. Although there may be error detection/correction there is no point-to-point control, handshaking, acknowledgements, retries, nor collisions. An example of “deterministic” is a microprocessor memory bus where by Ethernet is not. The significance of including a deterministic bus is that a deterministic bus can be designed such that the actual sustainable data transfer rate is nearly the full bandwidth of the physical bus itself. Thus, simulation architecture will operate at higher speeds the higher the bandwidth for both RAM and bus construction is used.

In some embodiments, the computational memory, bus, and computational logic processors may be configured with a high bandwidth data-flow, such that a current state vector in computational memory flows to the computational logic processor arrays and back as the next state vector to computational memory in minimal time with little or no external software intervention. Such a configuration reduces the simulation cycle time to a time it takes to read each element of current state from computational memory, compute each next state element, and write each element of the next state to computational memory.

In many forms of deterministic buses, such as daisy-chained FIFOs, there is no theoretical limit to the number of processors in the array. It is possible to turn all computationally limited simulations into Input/Output (I/O) limited simulations by supplying enough processors in an array. In a practical simulation system, a balance may be struck between I/O and computation time.

The actual organization of memory, buses, and processors is highly dependent on the simulation goals of the simulation system designers. As described herein, a simulation system designer can create a system wherein the speed of simulation is driven by the speed of both memory and bus. The exact implementation of the simulation system will depend on the overall goals of the simulation system due to the cost and performance differences based on the speed of the memory and bus utilized.

In some embodiments, the simulation system may be configured to provide high-end applications that can involve massive parallel simulation of logic processors on deterministic buses that extend across multiple circuit boards contained on and interconnected by motherboards or backplanes. This may involve simulation modeling of very large multiple chip systems such as an entire PC motherboard.

In some embodiments, the simulation system may be configured as a PC plug-in peripheral card and may be accessible to a more conventional simulation environment of hardware engineers.

The cyclic behavior described herein for state vector data emulates a repetitive “circuit” of data in the same sense that a telephone “circuit” repeats transporting voice signals along the same physical path. Simulation software in the host computer is responsible for definition and set up of these vector paths but plays no role in the actual transport.

The “little” software intervention cited above is directed at software needed to deal with modular pieces excluded from the main model, extra non-model features such as breakpoints, exceptions, and synchronization. The significance of this is that as the model grows in size, host management of the overall system grows to set up the system, but does not grow with execution of the system. A clarifying analogy would be to think of the host's responsibilities for a chip simulation is at the chip's pins (pin counts in hundreds) and the modeling covering the internal gates (counts of a few hundred to many millions).

Any combination of data storage devices, including without limitation computer servers, using any combination of programming languages and operating systems that support network connections, is contemplated for use in the present inventive method and system. The logic simulation method and system described herein are also contemplated for use with any communication network, and with any method or technology, which may be used to communicate with said network.

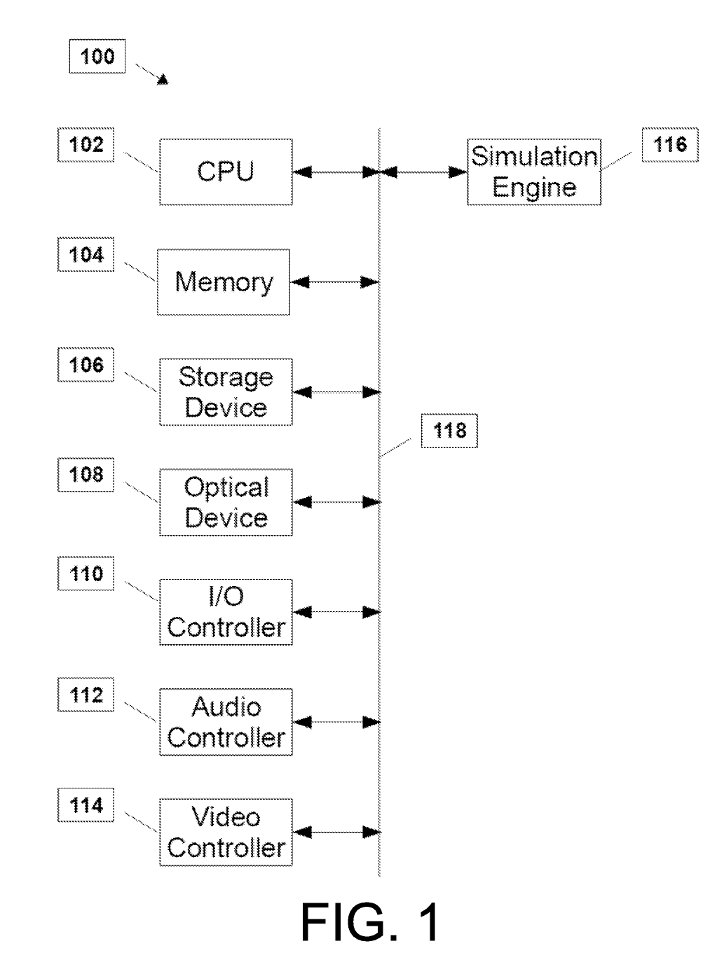

FIG. 1 is a block diagram illustrating an example computing system with a simulation engine, arranged in accordance with at least some embodiments of the present disclosure. FIG. 1 includes a computing device 100. Computing device 100 includes a CPU 102, a memory 104, a storage device 106, an optical device 108, an I/O controller 110, an audio controller 112, a video controller 114, and a simulation engine 116, all sharing a common bus system 118.

In FIG. 1, CPU 102, memory 104, storage device 106, optical device 108, I/O controller 110, audio controller 112, video controller 114, and simulation engine 116 are coupled to bus system 118. The components of computing device 100 may be located on one or more computer servers, virtual or cloud computing services, one or more user devices (such as smart phones, laptops, tablet computers, etc.), any other hardware, software, and/or firmware, or any combination thereof

In FIG. 1, CPU 102 is configured to use simulation engine 116 as part of the overall simulation environment. Either as a server or a client application, the software in CPU 102, which may also be referred to herein as host software, is configured to provide and manage the necessary simulation resources needed by the model. This host software also supports I/O elements of the simulation, commonly known as the “test fixture.” CPU 102 may comprise one or more of a standard microprocessor, microcontroller, and/or digital signal processor (DSP). In some embodiments, CPU 102 is configured to use simulation engine 116 but is not limited to the implementation of CPU 102.

In FIG. 1, memory 104 may be implemented in a variety of technologies. Memory 104 may comprise one or more of Random Access Memory (RAM), Read Only Memory (ROM), and/or a variant standard of RAM. Memory 104 may be configured to provide instructions and data for processing by CPU 102. Memory 104 may also be referred to herein as host memory or common memory.

In FIG. 1, storage device 106 may comprise a hard disk for storage of an operating system, program data, and applications. Optical device 108 may comprise a CD-ROM or DVD-ROM. I/O controller 110 may be configured to support devices such as keyboards and cursor control devices. Audio controller 112 may be configured for output of audio. Video controller 114 may be configured for output of display images and video data. Simulation engine 116 is added to the system through bus system 118.

In FIG. 1, the components of computing device 100 are coupled together by bus system 118. Bus system 118 may include a data bus, address bus, control bus, power bus, proprietary bus, or other bus. Bus system 118 may be implemented in a variety of standards such as Peripheral Component Interconnect (PCI), PCI Express, and Accelerated Graphics Port (AGP).

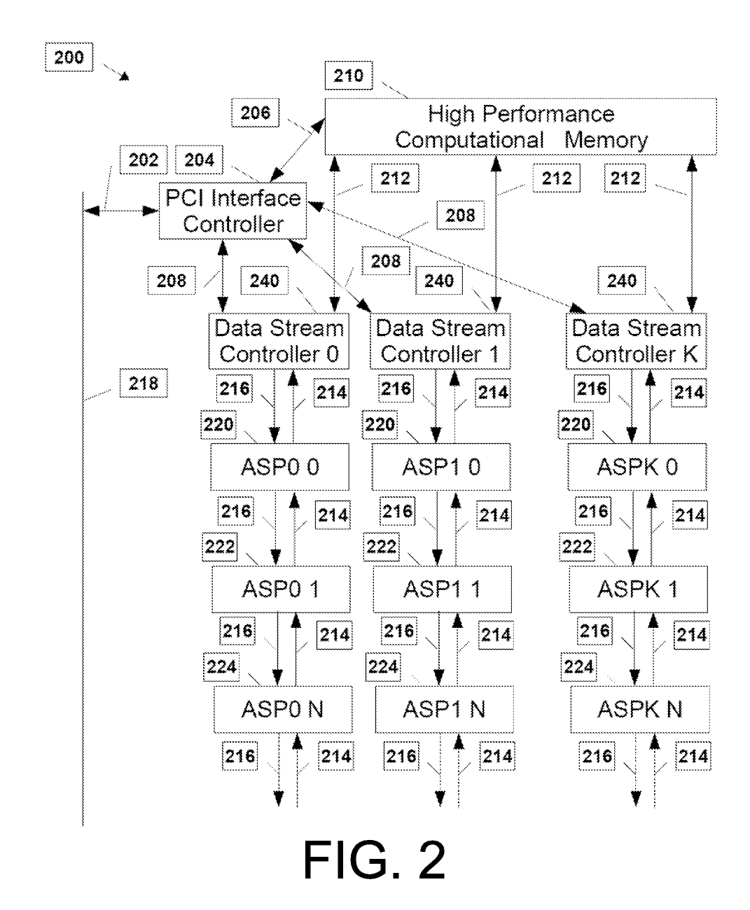

FIG. 2 is a block diagram illustrating an example simulation engine PCI plug-in card with logical modules, arranged in accordance with at least some embodiments of the present disclosure. FIG. 2 contains a simulation engine 200 comprising a PCI interface controller 204, a high performance computational memory 210, a plurality of Data Stream Controllers (DSCs) 240, including DSC 0, DSC 1, and/or further DSCs up to DSC K. Each DSC is coupled with a sub-array of computational logic processors. In FIG. 2, the computational logic processors are implemented by ASPs comprising ASPs 220, ASPs 222, and ASPs 224. The sub-array of computational logic processors for DSC 0 may comprise ASP0 0, ASP0 1, and/or further ASPs up to ASP0 N. The sub-array of computational logic processors for DSC 1 may comprise ASP1 0, ASP1 1, and/or further ASPs up to ASP1 N. The sub-array of computational logic processors for DSC K may comprise ASPK 0, ASPK 1, and/or further ASPs up to ASPK N.

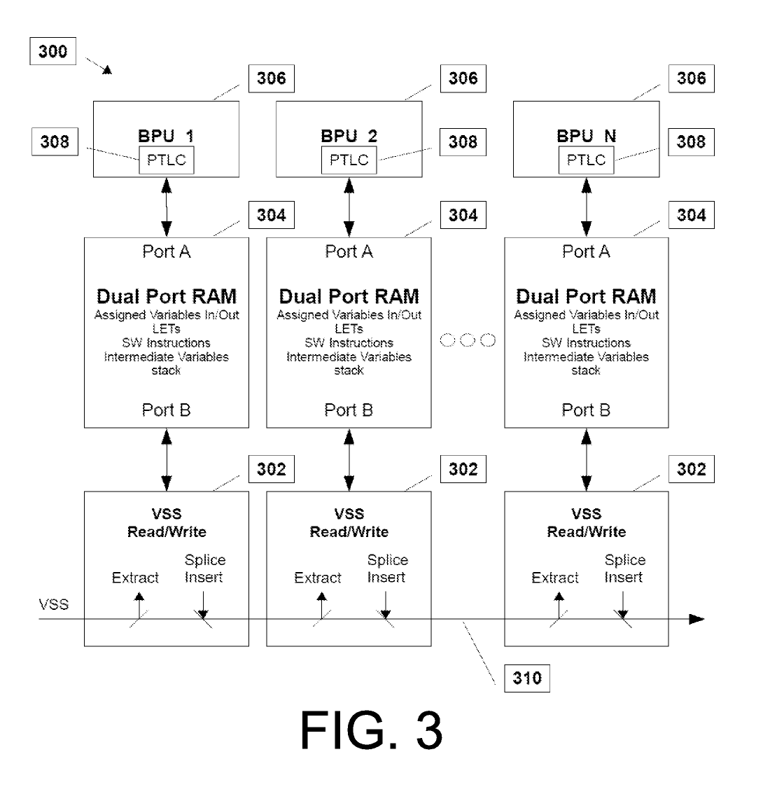

PCI interface controller 204 may be coupled to a bus system 218 by an interface 202. Bus system 218 may be identical to bus system 118 in FIG. 1. PCI interface controller 204 may interact with high performance computational memory 210 by transactions 206. PCI interface controller 204 may interact with DSCs 240 by transactions 208. High performance computational memory 210, which may also be referred to herein as computational memory 210, may interact with DSCs 240 by transactions 212. Each DSC 240 may be coupled with an array of ASPs by an inbound data stream 214 and an outbound data stream 216. Each ASP within a sub-array of ASPs may be coupled to each other in a linear fashion by inbound data stream 214 and outbound data stream 216. Inbound data stream 214 and outbound data stream 216 may be a VSS bus as shown in FIG. 3.

In some embodiments, PCI bus 202 may comprise PCIe version 1.1, 2.0 or 3.0, or any later developed version. The latter versions are backward compatible with PCIe version 1.1, and all are non-deterministic given they rely on a request/acknowledgement protocol with approximately a 20% overhead. Though some standards versions are capable of 250 MB/s, 500 MB/s, and 1 GB/s respectively, this may be too slow for host memory to act as “common” memory in some embodiments.

Computational memory 210 may be compatible with PCI interface controller 204. Computational memory 210 may comprise, e.g., a 64-bit wide memory. The data width of memory 104 depends on requirements, but is not restricted by PCI interface controller to 64-bit. The same memory can be configured to appear as 64-bit on the host port and 128-bit or 256-bit (or whatever is required) on the DSC 240 ports. With DDR2 (Double Data Rate) and DDR3 SDRAM (Synchronous Dynamic Random Access Memory) memory data transfer rates of 8.5 GB/s and 12.8 GB/s respectively, it is likely that host memory at 64-bit will be able to support more than one DSC 240, and 128-bit or 256-bit wide memory could support many DSCs. Further, simulation engine 200 may use computational memory 210 to service more than one array of processors. Computational memory 210 may be configured to ensure that the ASP array system does not become I/O limited.

Simulation engine 200 may comprise one or more DSCs 240. DSCs 240 may be referred to as DSC0, DSC1 . . . etc., up to “K” number of DSCs, which may be referred to as DSCK. Each of DSCs 240 may be configured to support a sub-array of one or more computational logic processors, such as the illustrated ASPs, where “N” refers to the number(s) of computational logic processors supported by DSCs 240.

In FIG. 2, ASPs 220 may be located one level away from DSC 240s. ASPs 222 may be located two levels away from DSCs 240. ASPs 224 may be located N levels away from DSCs 240, wherein “N” equals the last level of ASP away from DSCs 240. ASPs in an array controlled by DSC0 may be referred to as ASP0 0 for the first level of ASPs, ASP0 1 for the second level of ASPs, and ASP0 N for the Nth level of ASPs. ASPs in an array controlled by DSC1 may be referred to as ASP1 0 for the first level of ASPs, ASP1 1 for the second level of ASPs, and ASP1 N for the Nth level of ASPs. ASPs in an array controlled by DSCK may be referred to as ASPK 0 for the first level of ASPs, ASPK 1 for the second level of ASPs, and ASPK N for the Nth level of ASPs.

In FIG. 2, simulation engine 200 has a parallel instantiation of K numbered DSCs 240, wherein each DSC 240 shares access to computational memory 210, supports an array of N ASPs, where N may or may not be the same for the different DSCs 240, and is controlled by bus interface controller 204. Bus interface controller 204 may comprise a simple state machine or a full blown CPU with its own operating system. DSCs 240 may comprise simple Direct Memory Access (DMA) devices or memory management functions (scatter/gather) needed to get I/O between data stream controllers. The ASPs may be configured to be small, specific, and all alike. The first level ASPs 220 and Nth level ASPs 224 in each ASP sub-array may be configured to contain special provisions for being at the ends of an array. The last level ASPs 224 may be configured to provide a “loop back” function so that inbound data stream 214 joins outbound data stream 216.

In FIG. 2, computational memory 210 may be configured for direct control by mapping controls and status into memory 104 or host memory. Computational memory 210 contains the current and next state vectors of the simulation cycle. Contiguous input data and contiguous output data may be sent to simulation engine 200 from storage device 106 or memory 104. Data and delimiters are written in transactions 206 to computational memory 210 and are managed by the application executing on computing system 100. During initialization, ASP instructions and variable assignment data images are written by transactions 206 into computational memory 210 for later transfer by DSCs 240.

Prior to a computational cycle, new inputs are written in transactions 206 to computational memory 210. The inputs may be from new real data or from a test fixture. After the computational cycle, newly computed values can be read out in transactions 206 to PCI interface controller 204 and then transactions 202 for final storage into host memory.

In some embodiments, DSCs 240 may be configured to trigger the next computation or respond, via an interrupt, to the completion of the last computation or the trigger of a breakpoint. In some embodiments, DSCs 240 may comprise a specialized DMA controller with provisions for inserting certain delimiters and detecting others of its own. It may be responsible for completing each step in the cycle but the cycle may be under control of the host software.

Outbound data stream 216 comprises a new initialization or new data for processing by one of the ASPs within an ASP array. During initialization, outbound data stream 216 also provides information on the ASP types that are a part of the overall simulation system. Inbound data stream 214 comprises computed data from the last computational cycle or status information. The inbound and outbound data streams connect all ASP modules whether they are all in the same chip or split up among many chips. The last physical ASP within an ASP sub-array contains un-terminated connections (indicated by dashed lines).

FIG. 3 is a block diagram illustrating an example Boolean Logic ASP and its integration with a VSS bus, arranged in accordance with at least some embodiments of the present disclosure. FIG. 3 includes a sub-array of computational logic processors, embodied by an ASP array 300 comprised of N copies (3 shown). Each computational logic processor within ASP array 300 includes a Boolean processor unit (BPU) 306, a dual port RAM 304, a Vector State Stream (VSS) Read/Write 302, wherein the computational logic processors are coupled by VSS bus 310. BPUs 306 comprise PTLCs 308.

In FIG. 3, a BPU 306 may comprise a conventional Von Neumann processor, which executes machine instructions from a dual port RAM 304. A PTLC 308, which may also be referred to as a state machine, may be configured to use a dual port RAM 304 directly or utilize its own private RAM block (not shown). Like other Von Neumann processors, BPUs 306 may be configured to contain data move instructions to transfer data between PTLCs 308 and dual port RAMs 304. BPUs 306 may also be configured to contain unique instructions to invoke PTLCs 308 to process N entries of synthesized data in dual port RAMs 304. This set of synthesized data in conjunction with the instruction for PTLC execution comprises a synthetic machine instruction. Though the number of data move instructions may be hard coded into BPUs 306, the number of synthetic machine instructions need only be limited by memory size. Each BPU 306 can have the same or unique sets of synthetic machine instructions.

BPUs 306 and PTLCs 308 are separate companion state machines that can run concurrently or within one complex state machine. There are many ways to construct the physical state machines to help streamline the overall operation through better pipe-lining and other techniques.

In FIG. 3, VSS bus 310 may comprise a deterministic bus that transfers the current state vector in the input phase and the next state vector in the output phase. VSS bus 310 also carries delimiters that act as both commands and markers to denote data designated to each ASP. VSS Read/Write modules 302 may be configured to decode when to take inputs and when to produce outputs based on the delimiters in the bus stream. VSS Read/Write modules 302 illustrate one of several design possibilities of producing a very low overhead and high bandwidth method to “split” up a large state vector into smaller components suitable in size for dual port RAM 304. The same mechanism used for a “split” function in the VSS Read/Write modules 302 can also be used to recombine the computed output into the output stream. In some embodiments, the split and recombine functions may be executed without delimiters.

The VSS method puts more of the sophistication in VSS Read/Write modules 302 rather than any central controller, which allows the split management to scale with the number of ASPs or other computational logic processors in the system. It should be possible to manage state vectors with much less than 1% of the VSS bandwidth being used for delimiters. Notably, the vast majority of the bus bandwidth is used for propagation of vector data and the overhead of routing data does not suffer from the scale of the number of ASPs used in the array.

Unlike other simulation environments, the state vector need not be completely abstracted from hardware. The state vector may be configured with a specific form in host memory. Non-memory storage elements in the simulation model may be mapped into compact locations in computational memory for efficient transfer to and from the ASP arrays. In some embodiments, memory may be configured to use a specialized ASP designed for memory modeling.

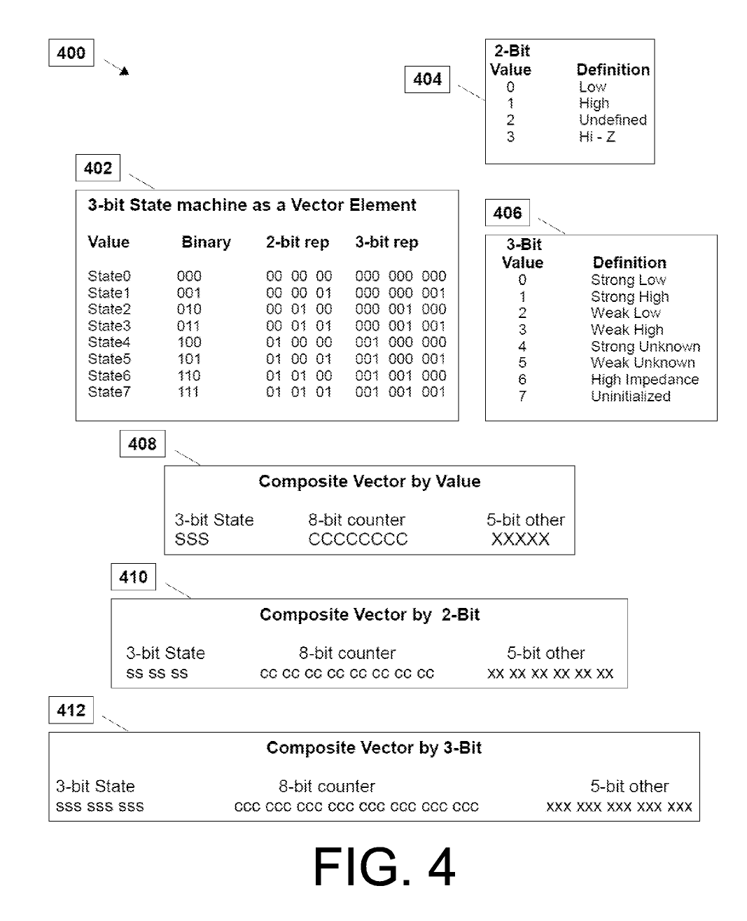

FIG. 4 is an example set of tables illustrating a definition of a state vector element and a composite state vector used for data storage and transport, arranged in accordance with at least some embodiments of the present disclosure. FIG. 4 includes data representations 400. Data representations 400 include a table of a 3-bit state machine as a vector element 402, a table of 2-bit value definitions 404, a table of 3-bit value definitions 406, a table of composite vector by value 408, a table of composite vector by 2-bit 410, and a table of composite vector by 3-bit 412.

In FIG. 4, the table of a 3-bit state machine as a vector element 402 displays single bit binary, 2-bit binary, and 3-bit binary representations in terms of symbolic value. A single bit only has two states so we cannot represent useful simulation states with a single bit. The choice of the correct actual binary may depend on the intent of the type of simulation. Most Boolean and real-time simulation can be handled with 2-bit representation, displayed in a table of 2-bit value definitions 404, and the remainder can be handled with 3-bit representation displayed in a table of 3-bit value definitions 406. In some embodiments, the simulation system may work equally well in 2-bit representation and 3-bit representation. In some embodiments, the simulation system may work well in greater than 3-bit representations. Because many models can be handled with 2-bit representation, and 2-bit representations generally correspond to the highest functional density and transport bandwidth, 2-bit representations are used for convenience in describing several of the representative embodiments herein.

Institute of Electrical and Electronics Engineers (IEEE) representations for logic are 8-bit, so a 32-bit word can contain only 4 variables. For cycle based simulation, only three states are needed, so a 2-bit representation a 32-bit word can contain 16 variables. For more complex operations, a 3-bit representation of logic may allow a 32-bit word to contain 10 variables. Utilizing a 2-bit or 3-bit transport and representation of logic supports dense functionality, high bandwidth transport, and calculation by the underlying machines. Conventional CPUs cannot do independent logic evaluations on individual or 8-bit fields of a 32-bit word in single instructions. The PTLC can do concurrent evaluation of 16 inputs of a 32-bit word in a single synthetic machine instruction.

In many computer systems, variables are often located in memory on 8-bit, 16-bit, 32-bit and 64-bit boundaries. In some embodiments, the “compiler” may be configured to pack small vector elements into a composite vector as displayed in composite vector by value 408. The example shown is typical for a small design module that contains a 3-bit state machine, a counter and 5 bits of other logic. The symbolic 16-bit composite vector may use 32-bits of storage or 24-bits of storage depending on simulation requirements. Composite vector by 2-bit 410 displays a 16-bit composite vector example. Composite vector by 3-bit 412 displays a 32-bit composite vector example.

In a high efficiency compilation environment, vector packing may be related to machine execution in addition to machine transport. Though the state vector represents the current or next state of memory elements, the state vector does not cover the combinatorial logic that connects the current state to the next state. Also included is a mechanism to cover combinatorial logic with a format very similar to state representation, allowing the compiler to organize packing for execution efficiency.

Another factor in the format of the state vector and vector packing is the ability of the ASP's VSS Read/Write module 302 to read or write multiple disjoint locations in the state vector as it flows on VSS bus 310. In some embodiments of this module, this may involve greater coordination by the compiler and perhaps some run-time reformatting of a small percentage of the vector. In other embodiments of this module, little or no coordination is necessary and the output vector could have an identical format to the input vector as well with no run-time intervention.

In some embodiments, the state vector may occupy a nearly contiguous block of locations in computational memory with only a few percent of unused space in the block, thereby reducing the actual memory I/O cycle between computational memory and the ASP arrays to close to the theoretical minimum.

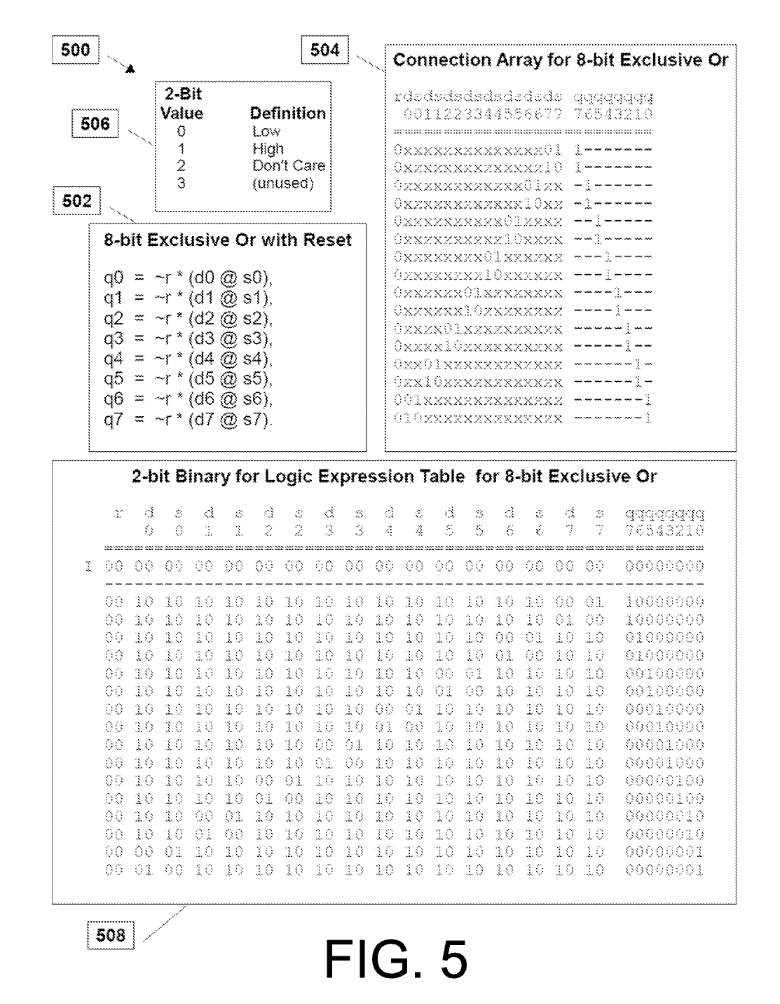

FIG. 5 is an example set of tables illustrating a definition of the Logic Expression Table (LET) used to define synthesized logic models for simulation, arranged in accordance with at least some embodiments of the present disclosure. FIG. 5 includes data representations 500. Data representations 500 includes a table of 2-bit logic definitions 506, a table of source equations of an 8-bit exclusive Or with reset 502, a table of a CAFE generated connection array for 8-bit exclusive Or 504, and a table of a 2-bit binary for Logic Expression Table (LET) for 8-bit exclusive Or 508.

In FIG. 5, data representations 500 illustrate an example of how source code in the form of some simple Boolean equations can be transformed into the LET using a simple logical construct. The LET, when coupled with the BPU instruction to execute, constitutes the synthetic machine instruction described above.

The table of an 8-bit exclusive Or with reset 502 illustrates a per bit expression for the combinatorial synthesis of an 8-bit exclusive Or with reset using CAFE syntax with the symbols “*”, “+,” “˜” and “@” corresponding to the operators “and,” “or,” “not,” and “Exclusive Or” respectively. The “d,” “r,” and “s” bits correspond with a portion of the current state vector and the “q” bits correspond with a portion of the new state vector. CAFE (Connection Arrays From Equations, published by Donald P. Dietmeyer) may be configured to synthesize connection array for 8-bit exclusive Or 504, which is a text notation for a Sum Of Products (SOP) form of equations. While similar to a truth table, the product terms are on the left-hand side with an indicator on the right-hand side indicating if that product term is connected to the output. A “1” in the right-hand side means “connected” and a “−” means “not connected.” As illustrated in this array q0=s0*˜d0*˜r+˜s0*d0*˜r.

For machine representation of the combinatorial, the simulation system may be configured to use the 2-bit format defined in 2-bit logic definitions 506 for the state vector, which support the values of “low,” “high,” and “don't care.” Using 2-bit logic definitions 506, connection array for 8-bit exclusive Or 504 may be converted to 2-bit binary for LET for 8-bit exclusive Or 508 while maintaining the same column ordering. The table of 2-bit binary for LET for 8-bit exclusive Or 508, which may also be referred to as the LET, can be used as a sequential look up table in machine execution. In some embodiments, the LET may be generated by the compiler such that the “s” and “d” bits would not be interleaved and would likely be in descending order.

The LET includes an inversion mask, row “I”, which allows individual bits of the inputs or the outputs of the LET to be expressed using inverted logic. The inversion is useful on the output side because in many logic expressions, the number of product terms is smaller (fewer entries in the LET) if the output is solved for zeros instead of ones. Inverting the inputs and outputs of a connection array allows one to find the smallest implementations to enable packing more functionality into smaller space. Logic reduction is an important step in synthesis due to its impact on the logic resources available. For inputs or outputs, it is convenient to allow all logic in the vector to propagate in a state that matches the polarity of the memory elements.

The state vector resides in computational memory 210 and migrates to and from the ASP array for processing into the next vector. The LET and any other methods of modeling logic structures may be distributed to and may reside in the ASPs. At simulation initialization, dual port RAM 304 are loaded with software and LETs and programmed with their assigned sections of the state vector.

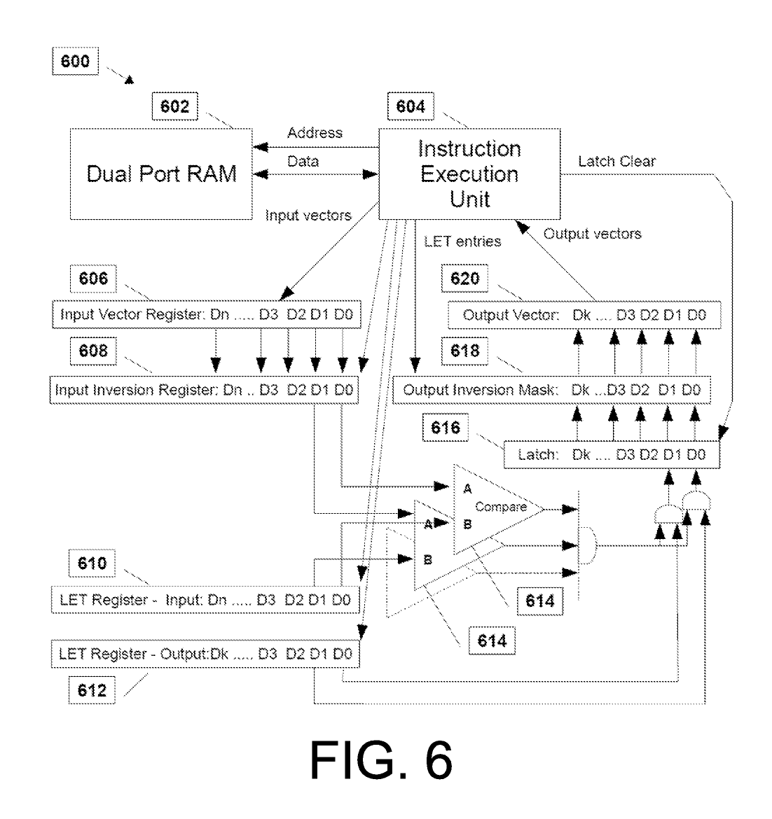

FIG. 6 is a block diagram illustrating an example PTLC, arranged in accordance with at least some embodiments of the present disclosure. FIG. 6 includes a BPU 600. BPU 600 includes a dual port RAM 602, an Instruction Execution Unit (IEU) 604, an input vector register 606, an input inversion register 608, a LET register for inputs 610, a LET register for outputs 612, logic comparators 614, an output latch 616, an output inversion mask 618, and an output vector register 620.

In FIG. 6, BPU 600 illustrates an example execution of a synthetic machine instruction to generate the LET in the PTLC. The PTLC is part of the microcode that evaluates logic while the LET is the other part of the microcode. Other instructions that BPU 600 may be configured to operate are not illustrated here. The simplified diagram only shows one port of dual port RAM 602 (the same as dual port RAM 304), IEU 604 (which has some not shown features common to all ASPs), and the components of PTLC 308.

In FIG. 6, IEU 604 may comprise a basic processor executing instructions from RAM like most other Von Neuman processors to move data between RAM and internal registers as well as to perform the functions for which the ASP is designed. Though the sophistication levels of ASPs containing a PTLC can vary considerably, usually with many additional non-PTLC components, only the PTLC components are shown here for clarity.

FIG. 6 is symbolic given that the actual bit representation is not shown. PLTCs can be built with 2-bit, 3-bit, or larger representations of the state vector bits. Input inversion mask 608, output inversion mask 618, and LET register for outputs 612 are all single bit per bit representations. Latch register 616 is 2-bits per bit and output vector register 620 may be equal to or larger than 2-bit per bit representation.

There is no reason for the number of input bits (n) or output bits(k) that make up the PTLC. There are some practical physical limits. At the low end, when a PTLC is used in conjunction with a Real Time Processing Unit (RTPU) the simulated gate delays are for real gates of usually 5 or less inputs and single outputs so the PLTC bit width is likely to be small. For idealized RTL (Boolean) simulation, the physical size can be quite large and determined by other physical properties such as VSS bus size or RAM port width.

In FIG. 6, IEU 604 has an instruction set that can move whole n-bit words from dual port RAM 602 to input vector register 606 or from output vector register 620 back to dual port RAM 602. Being that this is the most efficient method, advanced compilers used in conjunction with this system may be configured to “pack” LETs along with packing composite vectors into whole words for fast execution. IEU 604 may be configured to contain lesser bit moves to the extent that vector registers can be loaded and unloaded with individual vector elements.

An example operation may include one or more software instructions in IEU 604: (1) to load input vector register 606 from RAM 602; (2) to execute a LET at a specific RAM address 602; and/or (3) to move the contents of output vector register 620 back into dual port RAM 602.

The state machine within IEU 604 that executes the LET may be configured to: (1) clear the status in latch 616; (2) load input inversion register 608; (3) load output inversion register; and/or (4) sequentially load each LET entry into LET register for input 610 and LET register for output 612 until the list is exhausted.

Each 2-bit element of the status in latch 616 may be initialized to an “unmatched” status. Logic comparators 614 on a symbolic bit-by-bit basis may be configured to test the input vector to see if it matches LET register for input 610. Three possible results may include “unmatched,” “matched,” or “undefined”. The “don't care” LET input matches any possible input including “undefined.” All of the comparator outputs may be “anded” so that all of the comparators show a “matched” condition for there to be a product term match.

If there is a product term match, LET register for output 612 acts as an enable to route the status of the match to latch 616. It is referred to as a “latch” since once set to a status of “matched,” it may not be cleared until the next new LET evaluation. If latch 616 is set to “undefined,” it may retain this value as well unless overridden by a matched condition.

While the LET is being evaluated and latch 616 is taking on its final values, output inversion mask 618 may be applied and a new value, output vector register 620, may be created.

Being software based, IEU 604 can be programmed to handle multiple LETs and multiple sets of input vectors. IEU 604 may be limited by dual port RAM 602 capacity. Furthermore dual port RAM 602 may be utilized by IEU 604 software to support intermediate values. This is useful computation of terms common to more than one LET as input. An example of this is “wide decoding.” The width of the PTLC can be much smaller than the width of a word to be evaluated. The word is evaluated in more than one step in PTLC sized portions with results being passed on to the next step.

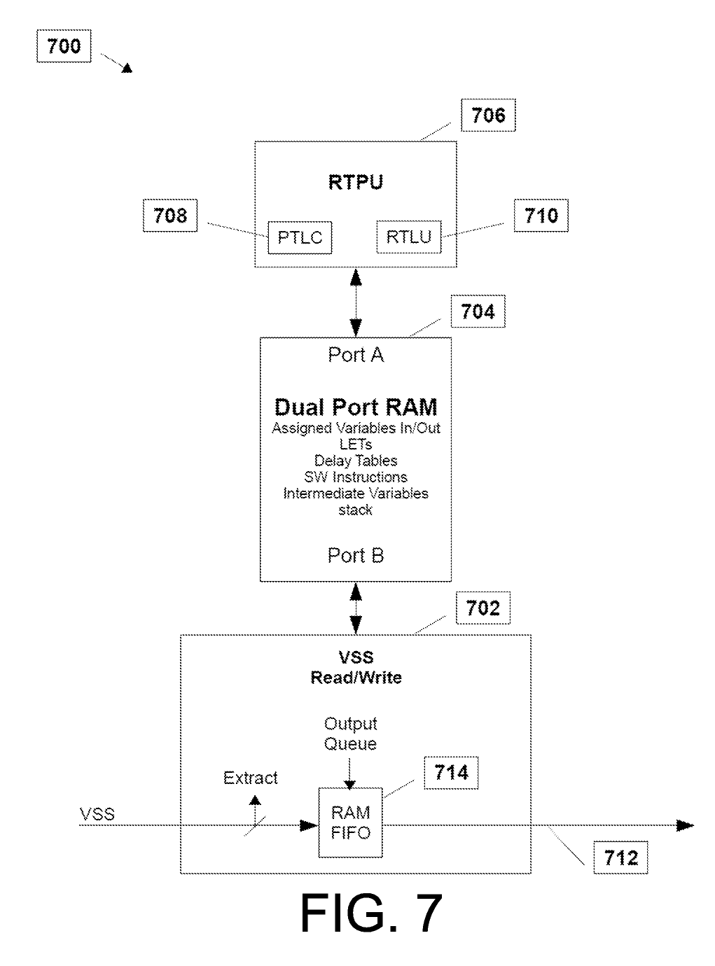

FIG. 7 is a block diagram illustrating an example Real Time Logic ASP and its integration with a VSS bus, arranged in accordance with at least some embodiments of the present disclosure. FIG. 7 illustrates one stage of a RTPU array 700, which includes a RTPU 706, a dual port RAM 704, a VSS read/write interface 702, a RAM based FIFO 714, and a VSS bus 712. RTPU 706 includes a PTLC 708 and a real time look up (RTLU) engine 710.

In FIG. 7, RTPU array 700 represents an expanded functionality of a Boolean ASP, illustrated in FIG. 3. BPU 306 may be configured to RTPU 706 by the addition of an RTLU engine that uses delay tables stored in dual port RAM 704. The delay tables contain propagation time in terms of pre-defined units.

In FIG. 7, PTLC 708 may be substantially similar to PTLC 308 in BPU 306 except may be much smaller. Real-time issues are more directed at synthetic primitives such as 2-input nand gates of gate-arrays or 4 to 6 input look up table RAMs in FPGAs. A combinatorial tree of many physical gates may be represented by a set of small LETs and delay tables for each signal path.

The input vector format for RTPU array 700 may be identical to the Boolean ASP, but the output vector can be different. In a Boolean Compatible Format (BCF) output, the calculated or look-up time delays determine in which vector cycle (each vector cycle represents one simulation clock cycle) the output changes. A calculated delay that violates set-up or hold for the technology at a clock edge can generate an “unknown” as an output. The BCF output may generate the correct real-time response but the timing details are hidden from any other analysis.

To support a more conventional real-time simulation environment, the Real Time Format (RTF) may be different than the Boolean compatible input. In any given simulation cycle the RTF outputs may be combined with Boolean output by simulation host software to calculate the next state. Because timing information is preserved for host software, more detailed analysis can be done at the penalty of a slower simulation cycle.

Because input and output are marked by delimiters and occur in separate phases of the simulation cycle, the mixture of Boolean input, BCF output, and RTF output are still compatible with VSS bus 712 bus behavior.

The Real Time ASP may contain an added component, RAM based FIFO 714, in VSS Read/Write module 702. Unlike the Boolean ASP, the RTF outputs may be marked with a time of change. After RTF outputs have been calculated, they may be put in time order in an output queue with time markers. During an output phase, time marker delimiters on VSS bus 712 stimulate VSS Read/Write module 702 to insert an output result into the VSS stream in VSS bus 712.

Before any RTF output is inserted, RAM based FIFO 714 may have a depth of 1. Inserting 1 output result delays VSS bus 712 input of RAM based FIFO 714 by one entry and the FIFO may then have a depth of 2. In some embodiments, the FIFO may have a maximum depth of N+1 for a Real Time ASP programmed to generate N RTF outputs.

Depth control is accomplished by RAM based FIFO 714 being constructed of a circular buffer in RAM with a separate input pointer and output pointer. When RAM based FIFO 714 is empty, both pointer values are identical. The “depth” may be defined as the number values written to RAM based FIFO 714 that have not yet been output.

The combination of a small amount of sorting in RTPU 706 and the ability to insert output into the stream in time order results in eliminating the need to sort all of the results in host memory. This simplifies the merging of real time results into the next state vector by host software.

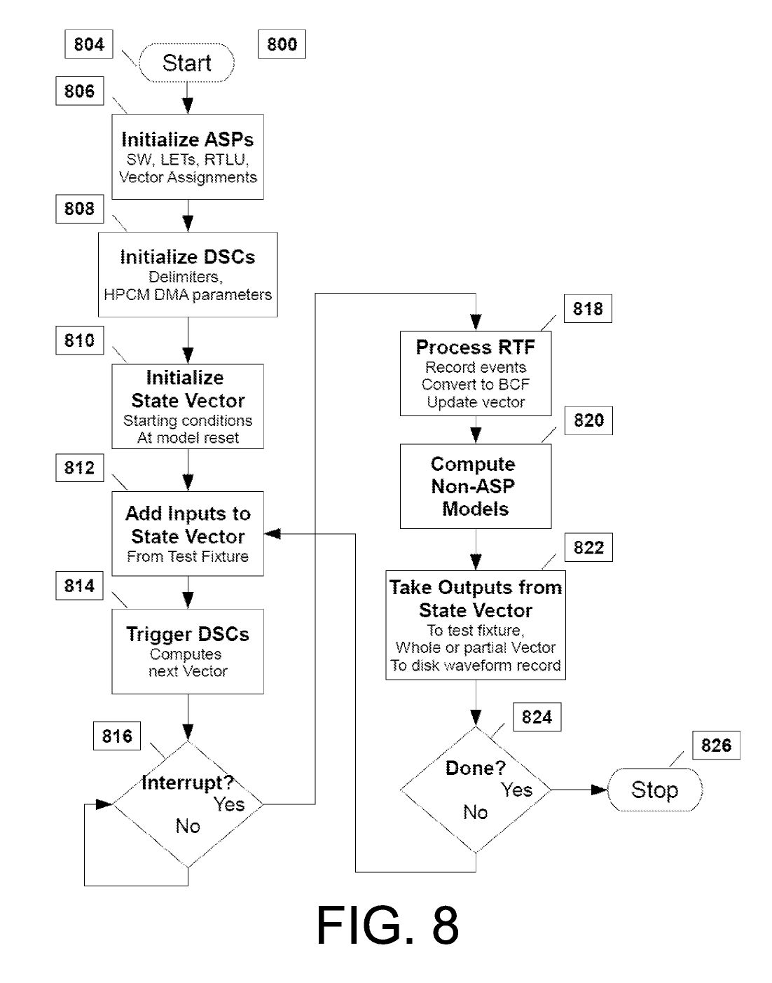

FIG. 8 is a flow diagram illustrating an example method configured to simulate a logic cycle from a host software perspective, arranged in accordance with at least some embodiments of the present disclosure. The example flow diagram may include one or more operations/modules as illustrated by blocks 804-826, which represent operations as may be performed in a method, functional modules in a computing device configured to perform the method 800, and/or instructions as may be recorded on a computer readable medium. The illustrated blocks, 804-826 may be arranged to provide functional operations of “Start” at block 804, “Initialize ASPs” at block 806, “Initialize DSCs” at block 808, “Initialize State Vector” at block 810, “Add Inputs to State Vector” at block 812, “Trigger DSCs” at block 814, “Interrupt?” at decision block 816, “Process RTF” at block 818, “Compute Non-ASP Models” at block 820, “Take Outputs from State Vector” at block 822, “Done?” at decision block 824, and “Stop” at block 826.

In FIG. 8, blocks 804-826 are illustrated as including blocks being performed sequentially, e.g., with block 804 first and block 826 last. It will be appreciated however that these blocks may be re-arranged as convenient to suit particular embodiments and that these blocks or portions thereof may be performed concurrently in some embodiments. It will also be appreciated that in some examples various blocks may be eliminated, divided into additional blocks, and/or combined with other blocks.

FIG. 8 illustrates an example method by which the computing device configured to perform method 800 may execute logic simulation, data distribution, and distributed execution, that enable the design and execution of machines used in logic simulation. The steps in FIG. 8 may implement a mixed mode simulation of real-time and Boolean modeling on a cycle-by-cycle basis. Because a focus of this disclosure is on state vector computing, details of the simulation environment (test fixtures, user inputs, display outputs, etc.) will not be presented. The scope of FIG. 8 is oriented toward the scenario of a PCI plug-in simulation engine as presented in other figures, but this strategy is extensible to more complex hardware architectures such as blades systems and large customized HPC solutions.

In a “Start” block 804, the computing device configured to perform method 800 may be configured to begin initialization steps by the host software in blocks 806, 808, and 810. The order of these three blocks may depend on the exact machine architecture and may be rearranged. Because ASP components can be implemented in both FPGA (Field Programmable Gate Arrays) and ASICs (Application Specific Integrated Circuits), initialization may involve steps not shown to program FPGAs to specific circuit designs and/or polling ASICs for their ASP type content.

In a “Initialize ASPs” block 806, the computing device configured to perform method 800 may be configured to partition the physical model among the ASPs available by loading software, LETs, RTLU, and whatever else is needed to make up what is known in the industry as one or more “instantiations” of a logic model. The “soft” portion of the instantiation is the LETs, delay tables, ASP software, etc. that make up re-usable logic structure. A “hard” instantiation is the combination of the soft instantiation with an assigned portion of the state vector that is used by the soft instantiation. Replication of N modules in a design is the processing of N portions of the state vector by same soft instantiation.

In a “Initialize DSCs” block 808, the computing device configured to perform method 800 may be configured to set up Direct Memory Access (DMA)-like streams of vectors in DSCs 240 to and from computational memory 210. Block 808 may be executed in conjunction with block 810.

In a “Initialize State Vector” block 810, the computing device configured to perform method 800 may be configured to reset initial state vector values. Block 810 may be executed in conjunction with block 808 because there is a partitioning of the state vector among the ASPs on any given DSC and among the multiple DSC and their ASP arrays that may be a part of the system. Partition affects the organization of the vector elements in computational memory 210 where the initial values of these elements reflect the state of the model at the beginning of the complete simulation (an initial point where the global reset is active).

In a “Add Inputs to State Vector” block 812, the computing device configured to perform method 800 may be configured to apply inputs from a test fixture. The input may be from specifically written vectors in whatever available HDL (High-level Description Language), from C or other language interfaces, data from files, or some real-world stimulus. Whatever the source, inputs may be converted into vector elements in a format detailed in FIG. 4 as one or more complete or part of one or more composite vectors. Block 812 starts the simulation cycle, which represents the computation of the next state.

In a “Trigger DSCs” block 814, the computing device configured to perform method 800 may be configured to trigger the DSCs 240. Triggering the DSCs 240 results in DSCs 240 sending out the complete current state vector from computational memory 210 to the ASP array where it gets processed. DSCs 240 receive and send forward to computational memory 210 the processed state vector (the nearly complete next state vector).

In a “Interrupt?” decision block 816, the computing device configured to perform method 800 may be configured to check for a host interrupt. When the current state vector has been fully processed into the next state vector, the done delimiter generates a host interrupt and triggers an instruction to load the next state vector into computational memory 210. When computational memory 210 has received the next state vector, the host software moves on to the next block.

In a “Process RTF” block 818, the computing device configured to perform method 800 may be configured to complete the processing of the new state vector by integrating real-time data in RTF form into BCF form and computing models not covered in the next block. As described herein, RTF form real-time information is more for the use of additional analysis and diagnostics, and becomes, in addition to a source of next vector information, a portion of the state vector outputs 822 so that the real time of state transition can be reported to the simulation environment or recorded.

In a “Compute Non-ASP Models” block 820, the computing device configured to perform method 800 may be configured to complete the processing of the new state vector by computing non-ASP models and models not covered in block 818.

In a “Take Outputs from State Vector” block 822, the computing device configured to perform method 800 may be configured to transmit and/or record a state vector output or portions thereof. In simulation environments, state vector output produced at block 822 may be used for a variety of purposes such as waveform displays, state recording to disk, monitoring of key variables and the control and management of breakpoints. After a simulation computational cycle, host software examines vector locations in computational memory 210 to extract whatever information may be necessary.

In a “Done?” decision block 824, the computing device configured to perform method 800 may be configured to detect when “done” conditions are met in the host test fixture software. “Done” may be indicated by a breakpoint condition or the completion of the number of simulation cycles requested by the simulation environment. If we are “done,” the host software may finish up with simulation post processing to complete session displays and controls in the simulation environment as presented to the user. If we are not “done,” the host software may advance minimal feedback to the user and we start a new cycle with new vector inputs by repeating blocks 812 through 824 until “done” conditions are met.

In some embodiments, the host software management of breakpoints and state vector extraction may become a control bottleneck to overall performance. It is likely that breakpoint ASPs and high-speed data channels from computational memory to mass storage media and other mechanism could be deployed for better vector I/O performance.

In a “Stop” block 826, the computing device configured to perform method 800 may be configured stop running a simulation.

In some embodiments, the simulation engine may execute “vector patching,” a processing type where computed vector components are relocated or replicated to facilitate the mapping of the inputs and outputs of various pieces of the simulation model. Patching could be done by host software (for example—in the Add Inputs step 812), DSC-like machines operating from computational memory, or special ASPs. Other processing may comprise part of the simulation system that are not illustrated in the flow chart or discussed herein.

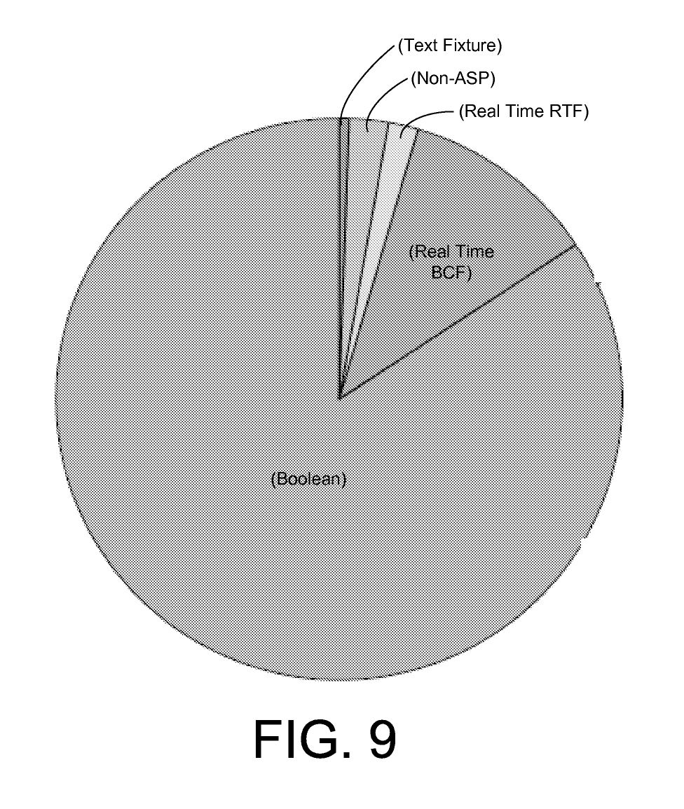

FIG. 9 is a pie chart of a mixed mode model, arranged in accordance with at least some embodiments of the present disclosure. FIG. 9 represents the computational work involved in each simulation cycle of an embodiment of the computing device configured to perform method 800 in FIG. 8. In FIG. 9, the computational work comprises Boolean, Real Time BCF, Real Time RTF, Non-ASP, and Test Fixture. The scope of FIG. 9 is limited to the ASPs presented in this disclosure. There are no restrictions on the sophistication of an ASP and many other types of processors possible for accelerated simulation. For models not covered by ASPs discussed herein, assume the models to be supplied by host software and are denoted as Non-ASP portions of the model in FIG. 9.

At the boundaries of the model, there are test fixture interfaces which make up the I/O boundaries for the application of stimulus and the gathering of results.

There is little distinction left between hardware and software implementations of aspects of systems; the use of hardware or software is generally a design choice representing cost vs. efficiency tradeoffs. There are various vehicles by which processes and/or systems and/or other technologies described herein may be implemented (e.g., hardware, software, and/or firmware), and that the preferred implementation may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof. Designing the circuitry and/or writing the code for the software and or firmware would be within the skill of one of skill in the art in light of this disclosure.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely examples and that in fact many other architectures may be implemented which achieve the same functionality.

While certain example techniques have been described and shown herein using various methods, devices and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed is:

1. A logic simulation method, comprising:
storing a state vector in a computational memory;
distributing, by each of multiple data stream controllers, an input comprising a portion of the state vector for processing by a sub-array of computational logic processors, wherein each of the multiple data stream controllers is coupled with a different sub-array of computational logic processors;
processing the inputs by a product term latching comparator within each of the computational logic processors;
sending, by the computational logic processors, computational results of processing the inputs to the data stream controllers;
sending the computational results, by the data stream controllers, to the computational memory; and
assembling the computational results into a new state vector in the computational memory.

2. The method of claim 1, wherein one or more of the computational logic processors comprises a Boolean computational logic processor or a real time computational logic processor.

3. The method of claim 1, wherein one or more of the computational logic processors are configured to provide modeling of logic constructions.

4. The method of claim 1, wherein one or more of the computational logic processors comprises a Field Programmable Gate Array (FPGA) or an Application Specific Integrated Circuit (ASIC).

5. The method of claim 1, wherein one or more of the computational logic processors comprises a real-time computational logic processor, and further comprising performing real-time look-ups by the real-time computational logic processor to determine timing of logic propagation and transition to simulate behavior of a physical circuit simulated by the logic simulation method.

6. A logic simulation system, comprising:
a computational memory configured to store an input state vector;
one or more deterministic data buses coupled with the computational memory, each of the deterministic data buses configured to propagate input and output state vector data;
multiple data stream controllers coupled with the one or more deterministic data buses, each of the data stream controllers configured to manage steps in a computational cycle completed by multiple computational logic processors; and
a plurality of sub-arrays of computational logic processors, each sub-array coupled with a data stream controller, wherein each of the computational logic processors comprises a product term latching comparator configured to compute a portion of a next state vector from the input state vector.

7. The logic simulation system of claim 6, wherein one or more of the computational logic processors comprises a Boolean computational logic processor or a real time computational logic processor.

8. The logic simulation system of claim 6, wherein one or more of the computational logic processors is configured to provide modeling of logic constructions.

9. The logic simulation system of claim 6, wherein one or more of the computational logic processors comprises a Field Programmable Gate Array (FPGA) or an Application Specific Integrated Circuit (ASIC).

10. The logic simulation system of claim 6, wherein one or more of the computational logic processors comprises a real-time computational logic processor, and wherein the real-time computational logic processor comprises a real time look up engine configured to perform real-time look-ups to determine timing of logic propagation and transition to simulate behavior of a physical circuit simulated by the logic simulation system.

11. The logic simulation system of claim 6, further comprising a host processor configured to run a simulation cycle, comprising triggering a simulation cycle and transmitting test fixture inputs and outputs.

12. The logic simulation system of claim 6, wherein one or more of the computational logic processors comprises a Boolean computational logic processor or a real time computational logic processor coupled with a dual port RAM, a Vector State Stream (VSS) module, and a deterministic data bus, wherein the dual port RAM is configured to store instructions, logic expression tables, and assigned input vectors, and wherein the VSS module is configured to splice input state vectors into components and to recombine computed output vector data into the deterministic data bus.

13. The logic simulation system of claim 12, wherein the VSS module coupled to the real time computational logic processor comprises a RAM based FIFO configured to sort output vector data based on time of change before the output vector is released to the deterministic data bus.
